(19) United States
(12) Patent Application Publication
(10) Pub. No.: US 2007/0211674 A1
(43) Pub. Date: Sep. 13, 2007

(54) Auto continuation/discontinuation of data download and upload when entering/leaving a network

(76) Inventors: Lars Johan Ragnar Karlberg, Lund (SE); Fredrik Oijer, Lomma (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/371,760

(22) Filed: Mar. 9, 2006

(51) Int. Cl. H04Q 7/24

(52) U.S. Cl. 370/338

(57) ABSTRACT

An electronic equipment for exchanging at least one of a first data or a second data over a first communication medium includes a first transceiver configured to exchange the first data and/or second data over the first communication medium, a data manager circuit for controlling data transfer over the first communication medium, and a user settable parameter corresponding to a characteristic of the first communication medium. The data manager circuit is operatively configured to automatically start, stop, and resume data transfer over the first communication medium based a comparison of the user settable parameter and the characteristic of the first communication medium.

### TECHNICAL FIELD OF THE INVENTION

The present invention relates generally to the field of mobile radio terminals and, more particularly, to a mobile radio terminal that automatically resumes data transfers on a wireless network, and to a mobile radio terminal that includes a conditional data transfer based on predetermined criteria.

### DESCRIPTION OF RELATED ART

Internet access via mobile phones is known. For example, mobile computers (e.g., laptops, PDA's, or the like) can use a mobile phone as a conduit to the internet, wherein the mobile phone acts as a modem for the computer. More specifically, the computer, via the mobile phone, utilizes the wireless mobile phone network to gain access to the internet. Further, mobile phones, such as “internet enabled” mobile phones, can be used to directly access the internet via the mobile phone network. Such “internet enabled” phones typically include a graphical display for viewing web pages, for example, and software that enables internet access, file transfers, web surfing, etc.

Due to the cost of mobile air time, use of mobile phones as a gateway to the internet can be expensive. This is particularly true when a predetermined amount of air time (e.g., when the number of minutes provided in the mobile plan) and/or data amount (e.g., when the amount of data provided in the plan) are exceeded. Also, costs can be significant when the user is not within a service area of the mobile phone (e.g., roaming). Further, data transfer rates over mobile phone networks are relatively slow compared to other transfer mediums.

As a partial solution to the above problems, mobile phones, in addition to communicating over cellular networks, also have been configured to communicate over wireless computer networks (e.g., via the 802.11a, b, or g standard), thereby providing an alternative avenue for obtaining internet access. For example, many businesses offer wireless internet access (generally referred to as “hot spots”), wherein anyone with wireless network adapter can access the network and the internet. An internet enabled phone equipped with a wireless network adapter and associated software can gain access to the internet in a manner similar to a conventional “wireless enabled” laptop computer. Moreover, the cost associated with internet access via a wireless computer network can be significantly less than the cost of internet access via a cellular network. Further, data transfer rates offered by wireless computer networks can be substantially higher than those offered by cellular networks.

### SUMMARY OF THE INVENTION

Internet access via mobile phones, whether using cellular phone networks or wireless computer networks, is a convenient way to access and send emails, exchange files or simply surf the web. While internet access via mobile phone networks can be relatively expensive, the use of computer networks significantly reduces these expenses while increasing data throughput. Both methods of internet access, however, can be subject to interruptions, wherein the internet cannot be accessed via a mobile phone network and/or a wireless computer network. Additionally, poor signal quality and/or interference can reduce the available bandwidth, thereby increasing transfer times. This is particularly true in regions where mobile service is limited and/or signals are weak, or where hot spots are not overly abundant. This can be problematic, particularly when uploading or downloading files. For example, if a file upload or download is initiated while in a hot spot (or while using the mobile network) and the upload/download is interrupted due to loss of signal, the entire upload/download is lost and must be manually reinitiated at a later time (e.g., when a signal is reestablished). In areas where signals are weak and/or hot spots are limited, file exchange via the mobile phone can be tedious and time consuming.

The present invention provides a device and method that enables automatic continuation/discontinuation of data transfers over a mobile radio terminal, such as a mobile phone, when entering or leaving a network, such as a mobile network or a wireless computer network. For example, if a file transfer is initiated via a mobile radio terminal and, prior to completing the transfer, network connectivity is lost, the file transfer is discontinued for the period that network connectivity is lost. Upon reestablishing a communication link, the file transfer can automatically resume from the point that it was previously discontinued. This process continues until the file transfer is complete or the process is canceled. One advantage of the invention is that a user need not reinitiate the file transfer each time the network link is lost and then reestablished. Further, since file transfers can be resumed from the point at which they were previously halted, the time required to perform the file transfer is reduced.

The invention also enables a user to manage data transfer settings so as to only transfer data when predetermined criteria are satisfied. The predetermined criteria can be based on available bandwidth of the communication medium, wherein data transfers are allowed only when the available bandwidth is above a preset threshold. Alternatively, the predetermined criteria can be based on a transfer cost per unit of data across the communication medium, wherein data transfers are only allowed when the transfer cost is below a predetermined threshold. This is advantageous, particularly in seamless and non-seamless roaming between networks having different topologies, as it enables the user to dictate which networks will be used for transferring large files. For example, if a data transfer is initiated on a high speed computer network and, due to roaming, the mobile radio terminal automatically switches to a low speed mobile network, the data transfer may be inhibited if the mobile network does not meet predefined criteria, such as bandwidth or cost per unit data of the network.

According to one aspect of the invention, an electronic equipment for exchanging at least one of a first data or a second data over a first communication medium, comprises: a first transceiver configured to exchange the first data and/or second data over the first communication medium; a data manager circuit for controlling data transfer over the first communication medium; and a user settable parameter corresponding to a characteristic of the first communication medium. The data manager circuit is operatively configured to automatically start, stop, and resume data transfer over the first communication medium based a comparison of the user settable parameter and the characteristic of the first communication medium. Further, the electronic equipment may be a mobile phone.

In one embodiment, the user settable parameter may be based on at least one of a valid communication link, a data transfer rate, or a transfer cost per unit data.

In another embodiment, resuming data transfer may include continuing data transfer from a point in which the data transfer was interrupted.

In yet another embodiment, a second transceiver may be configured to exchange at least one of the first data and/or the second data over a second communication medium. Additionally, the first communication medium and the second communication medium may be prioritized, and the data manager circuit automatically selects the first or second communication medium based on the comparison and the priority of the respective mediums.

In another embodiment, the first communication medium may be at least one of a local area network, a wide area network, a peer-to-peer network, or an internet connection, and the second communication medium is a mobile phone network.

In yet another embodiment, the data manager circuit comprises a processor and code executable by the processor. Alternatively, the data manager circuit comprises memory and code stored in the memory, and/or the code comprises firmware of the electronic equipment. In another embodiment, the data manager circuit is implemented in hardware.

According to another aspect of the invention, a method of transferring at least one of a first data or a second data to/from electronic equipment, comprises: exchanging the first data and/or second data over a first communication medium; monitoring a characteristic of the first communication medium; comparing the first characteristic to a user settable parameter to determine an availability of the first communication medium; and automatically starting, stopping, and resuming data transfer over the first communication medium based on the availability of the communication medium. The electronic equipment may be a mobile phone.

In one embodiment, comparing the characteristic to the user settable parameter may include using a user parameter that corresponds to at least one of a valid communication link over the communication medium, a predetermined data transfer rate over the communication medium, or a transfer cost per unit data over the communication medium.

In another embodiment, resuming data transfer may include continuing data transfer from a point in which the data transfer was interrupted.

In yet another embodiment, the method further includes exchanging at least one of the first data or the second data over a second communication medium; monitoring a characteristic of the second communication medium; and comparing the characteristic of the second communication medium to the user settable parameter to determine an availability of the second communication medium. Additionally, the method also comprises prioritizing the first and second communication medium; using the higher priority communication medium when the higher priority communication medium is available; and using the lower priority communication medium when the higher priority communication medium is not available. Further, the method may include periodically determining an availability of each communication medium.

The method of claim 1, wherein the first communication medium is at least one of a local area network, a wide area network, a peer-to-peer network, or an internet connection, and the second communication medium is a mobile phone network.

According to another aspect of the invention, a computer program embodied on a computer readable medium for transferring at least one of a first data or a second data to/from electronic equipment, comprises: code that exchanges the first data and/or second data over a first communication medium; and code that monitors a characteristic of the first communication medium; code that compares the characteristic to a user settable parameter to determine an availability of the first communication medium; and code that automatically starts, stops, and resumes data transfer over the first communication medium based on the availability of the first communication medium.

According to yet another aspect of the invention, a method of transferring at least a first data to/from electronic equipment, comprises: monitoring a first parameter of a first communication medium; monitoring a second parameter of a second communication medium, said second communication medium having a different topology than the first communication medium; comparing the first parameter and the second parameter to a user settable parameter, said user settable parameter defining a selection criteria; and selecting the communication medium that best satisfies the selection criteria.

To the accomplishment of the foregoing and the related ends, the invention, then, comprises the features hereinafter fully described in the specification and particularly pointed out in the claims, the following description and the annexed drawings setting forth in detail certain illustrative embodiments of the invention, these being indicative, however, of but several of the various ways in which the principles of the invention may be suitably employed.

Other systems, methods, features, and advantages of the invention will be or become apparent to one with skill in the art upon examination of the following drawings and detailed description. It is intended that all such additional systems, methods, features, and advantages be included within this description, be within the scope of the present invention, and be protected by the accompanying claims.

Although the invention is shown and described with respect to one or more embodiments, it is to be understood that equivalents and modifications will occur to others skilled in the art upon the reading and understanding of the specification. The present invention includes all such equivalents and modifications, and is limited only by the scope of the claims.

Also, although the various features are described and are illustrated in respective drawings/embodiments, it will be appreciated that features of a given drawing or embodiment may be used in one or more other drawings or embodiments of the invention.

It should be emphasized that the term “comprise/comprising” when used in this specification is taken to specify the presence of stated features, integers, steps or components but does not preclude the presence or addition of one or more other features, integers, steps, components or groups thereof.”

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a block diagram illustrating an exemplary communications.

FIG. 2 is a block diagram of an exemplary mobile phone.

FIGS. 3A-3D are exemplary flow charts illustrating a method of implementing automatic continuation/discontinuation of file transfers in accordance with the invention.

FIG. 4 is another exemplary flow chart illustrating a method of implementing automatic continuation/discontinuation of file transfers in accordance with the invention.

### DETAILED DESCRIPTION OF EMBODIMENTS

The term electronic equipment includes portable radio communication equipment. The term portable radio communication equipment, which hereinafter is referred to as a mobile radio terminal, includes equipment such as mobile telephones, communicators, i.e., electronic organizers, personal digital assistants (PDAs) smart phones or the like. While the invention is described with respect to file transfers from electronic equipment to other devices, it should be appreciated that the invention also is applicable to file transfers from other devices (e.g., a personal computer) to electronic equipment.

The present invention enables electronic files, such as data files, executable files, multi-media files, text files, etc., to be transferred from electronic equipment, such as a mobile phone, to another device, such as a personal computer (PC), another mobile radio terminal, or any other electronic device that can receive and/or transmit data over a communication link. The data transfer can be performed via a mobile network (e.g., a cellular phone network), a computer network (e.g., a wireless computer network or WLAN), a Bluetooth network, a peer-to-peer connection, an internet or intranet connection, or any other communication medium that facilitates wireless transfer of information. Once a data transfer is initiated, the transfer is automatically stopped and started based on the availability of the communication medium. Moreover, as a data transfer resumes after being stopped, the transfer resumes from the point that data was last successfully transferred. In this manner, the entire file need not be retransmitted, thereby reducing the time of the transfer.

For example, a file transfer can be initiated on a mobile radio terminal via a high speed communication link (e.g., a WLAN connection to another computer). Such a communication link typically is preferred over a mobile network connection, as it generally provides greater data throughput at a lower cost relative to the mobile network connection. Due to the mobile nature of the mobile radio terminal, however, the high speed link signal may become terminated as the mobile radio terminal is moved in and out of range of a transmitter and/or receiver. As the signal is terminated, the mobile radio terminal of the present invention automatically discontinues data transfer and enters a monitor or sleep mode. During sleep mode, the mobile radio terminal periodically checks whether the high speed communication link is available. Once the high speed link is available and a communication link is reestablished, the data transfer is automatically resumed from the point at which it was last terminated, without requiring user intervention. In this manner, the transfer time is minimized as the system does not need to retransmit the entire file. Instead, only that portion of the file that has not yet been transferred is sent. Further, the user need not monitor whether or the transfer was successful. Instead, the user can initiate the transfer and then move on to other tasks, knowing that if communications are interrupted, the mobile radio terminal will automatically resume transmission once communications are reestablished.

Alternatively, multiple networks having different topologies may be available to the mobile radio terminal. One topology may have greater bandwidth than the other, which makes this network more attractive for file transfers. When multiple networks are available, the mobile radio terminal may automatically and seamlessly transfer from one network to another while maintaining the file transfer. For example, a data transfer may have been initiated on a first network (e.g., a cellular network) having a first data transfer rate. During the transfer, the mobile radio terminal detects a second network different from the first network, wherein a bandwidth of the second network is greater than the bandwidth of the first network. The mobile radio terminal may automatically and seamlessly switch networks such that the network with the greater bandwidth is utilized, without losing any portion of the data already transferred.

Availability of the communication medium can be based on a number of factors. In an exemplary embodiment, availability is based on whether or not a communication link can be established via any communication medium. In other words, if a communication link can be established over the communication medium, then the communication medium is said to be available. Conversely, if a communication link cannot be established over the communication medium, then the communication medium is said to be unavailable.

In another exemplary embodiment, network availability is based on a minimum data transfer rate over the communication medium. As is well known, data transfer rate over a communication medium can vary based on a number of factors, such as, for example, the strength of the signal and/or interference generated by other devices. According to this embodiment, even when a communication link may be established over one of the communication mediums, if the data transfer rate is below a preset threshold, then the communication medium is said to be unavailable. Conversely, if the data transfer rate is equal to or greater than the preset threshold, then the communication medium is said to be available. The threshold transfer rate can be a user settable parameter, for example.

In another exemplary embodiment, availability can be based on a cost of access and/or transfer cost per unit of data. For example, a user can specify to transfer data only when the per unit data transfer cost is below a user settable amount. If the transfer cost is less than the specified amount, then the communication medium is said to be available. Conversely, if the transfer cost is equal to or greater than the specified amount, then the communication medium is said to be unavailable.

In yet another embodiment, each communication medium can be given a priority, wherein a communication medium with a high priority is preferred over a communication medium with a low priority. For example, the computer network can be given a priority of 1, while the mobile network can be given a priority of 2 (in this example 1 is a higher priority than 2). If both communication mediums are deemed to be available, then the “higher priority” communication medium is used to transfer the data, which in this example is the computer network interface. Should the higher priority medium become unavailable sometime after the transfer has been initiated, then the mobile radio terminal can automatically switch to the next lower priority communication medium, which in this case would be the mobile network interface. If some time later the computer network interface (the higher priority communication medium) becomes available, then the mobile radio terminal can automatically switch back to computer network interface. This is advantageous as the mobile radio terminal can be configured to utilize the best available communication medium (e.g., best transfer rate, lowest cost, etc.), while attempting to maintain data transfers in the event a preferred communication medium is unavailable. Availability, as used with respect to the prioritized communication mediums, can be based on one or more of the above described methodologies for determining communication medium availability.

Switching between the first and second networks mediums during a data transfer can be accomplished, for example, by maintaining a checkpoint on the source (e.g., the mobile radio terminal) and/or destination (e.g., a PC, another mobile radio terminal, a server, etc.) devices, wherein the checkpoint identifies the data that was last successfully transferred. As the mobile radio terminal switches from one network medium to another, the mobile radio terminal can retrieve the checkpoint and determine where to resume the data transfer such that data is not lost and transfer time is minimized.

The mobile radio terminal can be configured such that both the data continuation/discontinuation feature and the data transfer management features (e.g., transfers based on bandwidth and/or transfer cost per unit of data) are implemented in combination with one anther or separate from one another. For example, a first mobile radio terminal may only include a data transfer manager based on bandwidth and/or transfer costs, a second mobile radio terminal may include only the automatic continuation/discontinuation feature, and a third mobile radio terminal may include both the automatic continuation/discontinuation feature and the data transfer management feature.

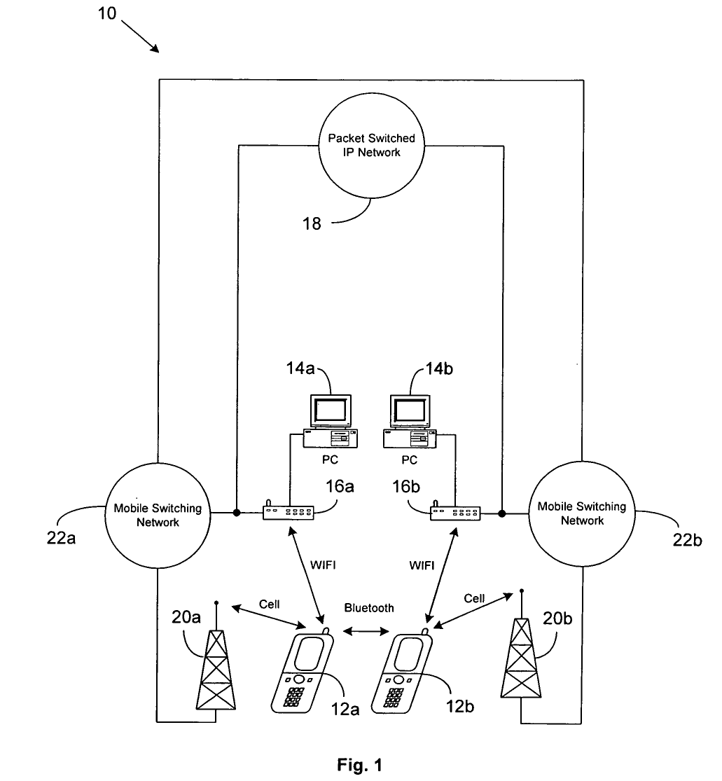

Referring now to FIG. 1, there is shown an exemplary diagram 10 illustrating various communication mediums that can be used for electronic equipment embodied as mobile phones. A first and second mobile phone 12a and 12b can transfer data via a number of different conduits. For example, data can be directly transferred between the respective phones using a Bluetooth communication link. Alternatively, data can be transferred from the first mobile phone 12a to a first PC 14a, a second PC 14b and/or the second mobile phone 12b, and vice-versa, via a WLAN (also referred to as WIFI) connection using a wireless router 16a and 16b and/or a packet switched IP network 18 (e.g., the internet and/or intranet, a local area network, a wide area network, etc.). Additionally, data may be transferred from the first mobile phone 12a to the first PC 14a, the second PC 14b or the second mobile phone 12b, and vice-versa, via a mobile communication link using towers 20a and 20b and mobile switching networks 22a and 22b. As will be appreciated, a number of other connections may be established that are not shown in FIG. 1. For example, a Bluetooth communication link may be established between the mobile phones 12a and 12b and the PCs 14a and 14b.

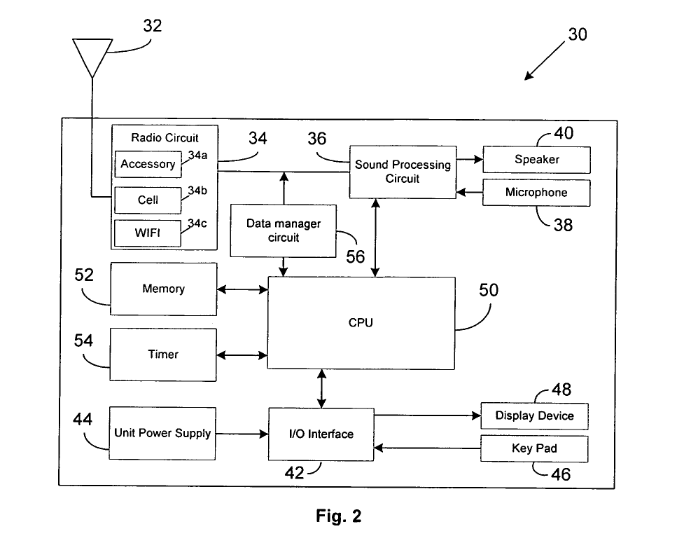

Moving now to FIG. 2, a block diagram of an exemplary mobile phone 30 that can be used in conjunction with the invention is shown. The mobile phone 30 includes an antenna 32 operatively coupled to a radio circuit 34. The radio circuit 34 can include an accessory transceiver 34a (e.g., Bluetooth or other wireless communications technique) for communicating with an accessory or other electronic equipment, a conventional mobile phone transceiver 34b for communicating via a conventional mobile phone network (e.g., via towers or satellite), and a wireless network transceiver 34c (also referred to as WIFI or WLAN) for wirelessly communicating with a LAN or WAN, for example. Although not shown, it will be appreciated that separate antennas may be provided for each of the respective radio circuits 34a, 34b and 34c. The mobile phone also includes a sound processing circuit 36, which, in conjunction with a microphone 38 and speaker 40, enable sound to be input and output from the mobile phone 30. Further, an I/O interface 42 distributes power from a power supply 44 (e.g., a battery) to the various sections of the mobile phone 30, and the I/O interface 42 receives data from a key pad 46 and provides data to a display 48. The radio circuit 34, sound processing circuit 36 and I/O interface 42 are operatively coupled to a processor 50 (e.g., a CPU), which, in conjunction with memory 52 and timer 54, executes code stored in memory 52 so as to implement the mobile phone functionality, e.g., wireless voice communications, recognition of keypad entries, display control, WAN interface, data transfer, accessory communications, etc. A data manager circuit 56 is coupled between the CPU 50 and the radio circuit 34 and performs the automatic continuation/discontinuation described herein.

The data manager circuit 56 may be completely or partially implemented via software and/or firmware. For example, executable code may be stored in memory 52, wherein when the CPU 50 executes the code, the automatic continuation/discontinuation of data transfer and/or data transfer management described herein is/are implemented. Alternatively, or in conjunction with, portions of the data manager circuit may be implemented via hardware. That is, logical circuits can be configured so as to implement all or portions of the automatic continuation/discontinuation functionality described herein.

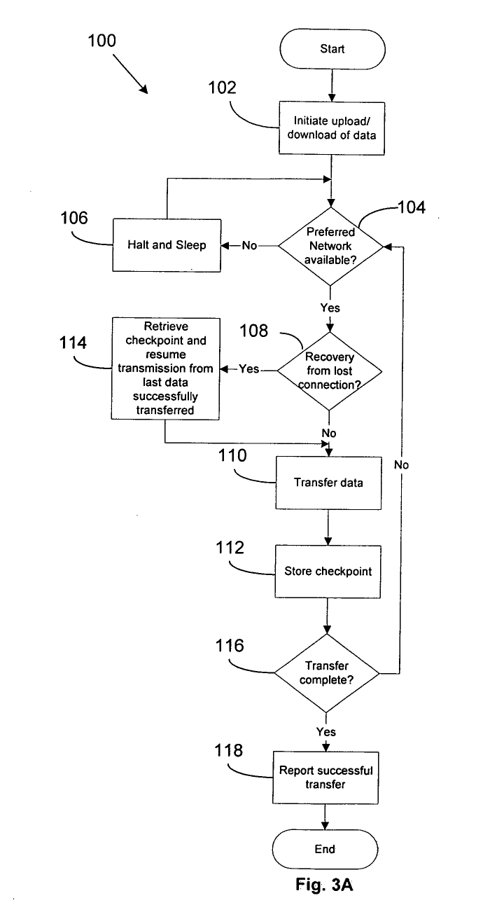

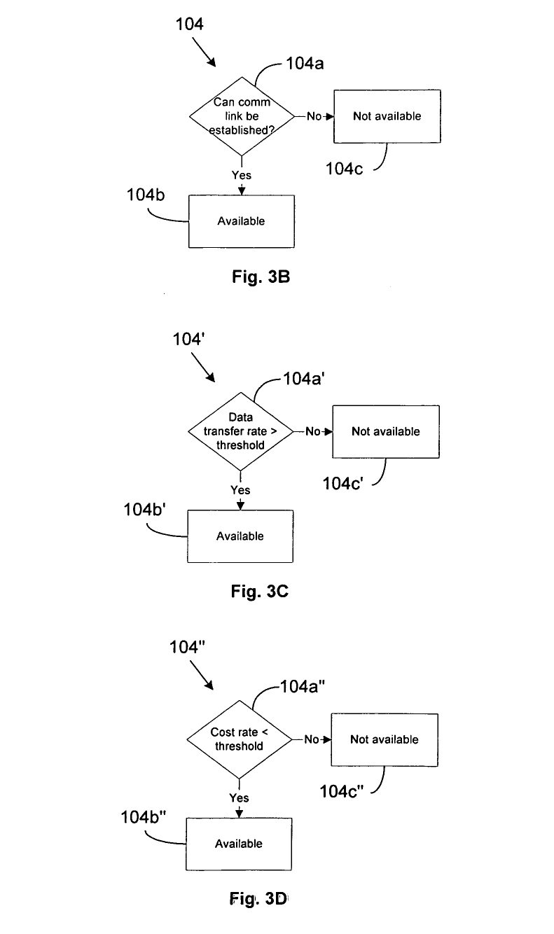

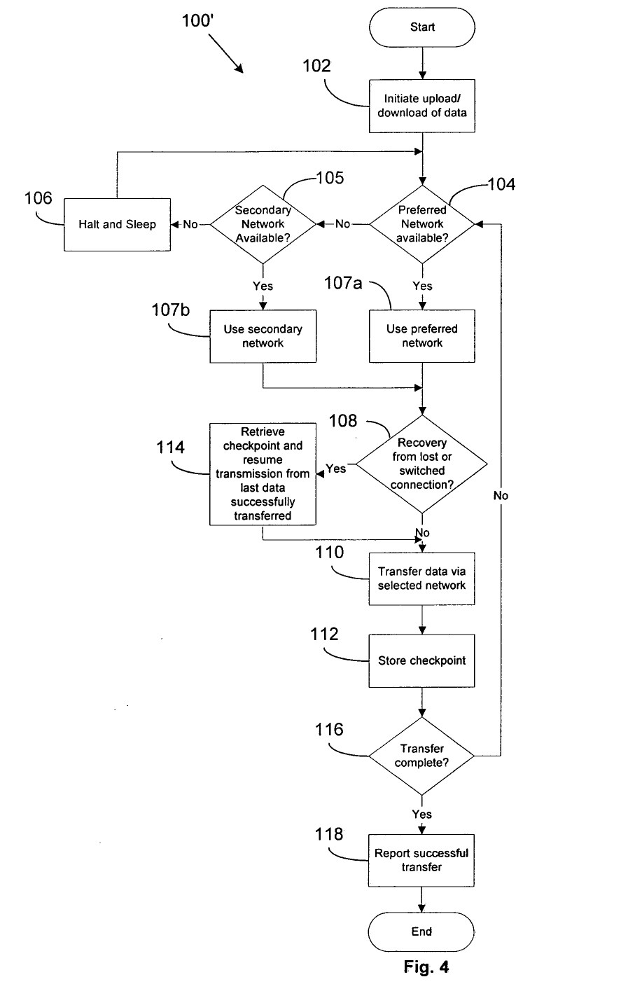

Referring now to FIGS. 3A-3D and 4, flow diagrams 100 and 100′ illustrating exemplary methods for implementing the data manager circuit 56 in a mobile radio terminal are provided. The flow diagrams include a number of process blocks arranged in a particular order. As should be appreciated, many alternatives and equivalents to the illustrated steps may exist and such alternatives and equivalents are intended to fall with the scope of the claims appended hereto. Alternatives may involve carrying out additional steps or actions not specifically recited and/or shown, carrying out steps or actions in a different order from that recited and/or shown, and/or omitting recited and/or shown steps. Alternatives also include carrying out steps or actions concurrently or with partial concurrence.

Beginning at step 102 of FIG. 3A, a user initiates a file transfer from the mobile radio terminal to another device, such as the user's home PC, for example. A file transfer can be initiated, for example, using the key pad 46 in conjunction with the display 48, wherein a menu system can simplify entry of commands into the mobile radio terminal (e.g., a scroll bar displaying several commands, each of which may be selected using up/down scroll keys). Once the file transfer has been initiated, then at step 104 the data manager circuit 56 determines if the preferred communication medium is available. For example, the mobile radio terminal can scan and detect the presence of a network (e.g., WLAN or mobile) and determine parameters of the network (e.g., bandwidth, costs per unit data, etc.) as discussed in more detail below. Preferably, the preferred communication medium is a high speed computer network that can be accessed via a wireless connection (e.g., a wireless router).

The preferred communication medium can be user selectable. For example, in regions that have a high number of hot spots, it is advantageous for the user to choose a wireless computer network as the preferred communication medium. In this manner, high speed data transfers are possible while minimizing costs associated with the data transfer. In certain regions, however, the number of hot spots may be limited or they may not exist at all. In such situations, the user may wish to change the preferred communication medium to the mobile network of the mobile radio terminal. While mobile networks generally provide less throughput at a higher cost, this option enables file transfers when other means are not available.

If the preferred communication medium is not available, then at step 106 any transfer is halted and the method goes into a sleep mode. Sleep mode introduces a delay before attempting to reconnect with the preferred communication medium. Generally, sleep mode can be set for a few seconds, minutes, hours, or more depending on the region and preferences of the user. In urban regions, for example, the sleep mode may be set for one minute or less, as the distance from one hot spot to another may be relatively short. In rural regions, however, the sleep mode may be longer, since hot spots typically are relatively farther apart. By increasing the sleep time in regions that are known to have dispersed hot spots, battery power can be conserved, as the radio circuit 34 need not continuously scan for available signals. The actual sleep time can be a preset value that can be user adjustable. Once the sleep time has expired, the method moves back to step 104 and checks of the preferred communication medium is available.

If the preferred communication medium is available, then at step 108 it is determined if a recovery or restart is being attempted. In other words, it is determined if the system is recovering from a lost or interrupted connection wherein at least a portion of the file had been transferred. If the system is not recovering, then at step 110 the file transfer takes place and at step 112 a checkpoint is stored in memory. As is known in the art, checkpointing is the process of taking a running process and freezing its state to storage, so that it can later be resumed from the point in its execution at which it was checkpointed. The checkpoint is used during the recovery process to determine where the transfer was interrupted and, thus, where to begin transfer once a communication medium is once again available after interruption. File transfers may be directed to the receiving device (e.g., another mobile phone or a PC), or to an intermediate device (e.g., a server operated by the mobile or computer network provider) and maintained there until the file is completely uploaded/downloaded.

Moving back to step 108, if the system is recovering, then at step 114 the checkpoint is retrieved from memory and, based on the information contained therein, the transfer is resumed from the point where the transfer was interrupted. As was noted previously, this is advantageous in that the transfer need not restart from the beginning each time a communication link is lost.

At step 116, a determination is made whether or not the file transfer is complete. If the file transfer is not complete, then the method moves back to step 104 and repeats the subsequent steps. If, however, the file transfer is complete, then at step 118 the user is informed that the transmission was successful. This report may be a simple message on the display 48 of the mobile radio terminal, an email to the user's email address, an audible alert, or any other means for informing the user on the status of the transmission.

Moving now to FIGS. 3B, 3C and 3D, exemplary methods of implementing step 104 of FIG. 3A are shown. In step 104a of FIG. 3B, it is determined if a communication link can be established over the network. If a communication link can be established, then at step 104b the network is marked as being available. If, however, a communication link cannot be established, then at step 104c the network is marked as unavailable.

In step 104a′ of FIG. 3C, it is determined if a data transfer rate is greater than a predefined threshold. If the data rate is greater than the threshold, then at step 104b′ the network is marked as being available. If, however, the data rate is less than or equal to the threshold, then at step 104c′ the network is marked as unavailable. Thus, the method of FIG. 3C not only requires that a communication link be established, but that the communication link is of sufficiently quality to enable data transfer at a predefined rate (which may be fixed or user selectable).

In step 104a″ of FIG. 3D, it is determined if a transfer cost per unit of data is greater than a predefined threshold (e.g., a user settable threshold). If the cost is less than the threshold, then at step 104b′ the network is marked as being available. If, however, the cost is greater than or equal to the threshold, then at step 104c′ the network is marked as unavailable.

Moving now to FIG. 4, another exemplary method for implementing the data manger circuit 56 is shown. Many of the steps of FIG. 4 are identical to FIG. 3A and thus will only be briefly discussed. Beginning at step 102 of FIG. 4, a user initiates a file transfer from the mobile radio terminal to another device, such as the user's home PC, for example. Once the file transfer has been initiated, then at step 104 the data manager circuit 56 determines if the preferred communication medium (e.g., the highest priority medium) is available. In the present example, the preferred communication medium is a high speed computer network. If the preferred communication medium is available, then the preferred communication medium is selected for data transfer as indicated at step 107a, and the method proceeds with steps 108-118 as described above with respect to FIG. 3A.

If the preferred communication medium is not available, then the method moves to step 105 and determines if the secondary communication medium (e.g., the next lower priority medium) is available. The secondary communication medium may be a mobile phone network, for example. If the secondary communication medium is not available, then the method proceeds with step 106 (i.e., halt and sleep mode) and then returns to step 104 as described above. If the secondary communication medium is available, then the secondary communication medium is selected for data transfer as indicated at step 107b, and the method proceeds with steps 108-118 as discussed above. If the higher priority communication medium becomes available prior to completion of the data transfer, then the method reverts back to the preferred communication medium for data transfer.

Alternatively, the system can be configured so has to only use a preferred network, even if other networks are available. For example, networks that are not to be used can be given a priority of −1, for example. When the system detects a priority of −1, it can mark that network as unavailable for data transfers, even if it actually is available.

Thus, the method of FIG. 4 selects the best communication medium available and uses that communication medium for transmission. While the method of FIG. 4 may not be the most cost effective, it enables a file transfers in the shortest time possible taking into account the available transfer mediums. As will be appreciated, the method of FIG. 4 can be expanded to include more than two networks (e.g. a third network such as a Bluetooth link could be added).

Accordingly, a device and method for automatic continuation/discontinuation of a file transfer via a mobile radio terminal has been disclosed. The invention is advantageous in that it enables efficient use of network mediums. Further, file transfer times as well as costs associated with the file transfers can be reduced.

Specific embodiments of an invention have been disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. An electronic equipment for exchanging at least one of a first data or a second data over a first communication medium, comprising:
a first transceiver configured to exchange the first data and/or second data over the first communication medium;
a data manager circuit for controlling data transfer over the first communication medium; and
a user settable parameter corresponding to a characteristic of the first communication medium, wherein the data manager circuit is operatively configured to automatically start, stop, and resume data transfer over the first communication medium based a comparison of the user settable parameter and the characteristic of the first communication medium.

2. The device of claim 1, wherein the user settable parameter is based on at least one of a valid communication link, a data transfer rate, or a transfer cost per unit data.

3. The device of claim 1, wherein resuming data transfer includes continuing data transfer from a point in which the data transfer was interrupted.

4. The device of claim 1, further comprising a second transceiver configured to exchange at least one of the first data and/or the second data over a second communication medium.

5. The device of claim 4, wherein the first communication medium and the second communication medium are prioritized, and the data manager circuit automatically selects the first or second communication medium based on the comparison and the priority of the respective mediums.

6. The device of claim 1, wherein the electronic equipment is a mobile phone.

7. The device of claim 1, wherein the first communication medium is at least one of a local area network, a wide area network, a peer-to-peer network, or an internet connection, and the second communication medium is a mobile phone network.

8. The device of claim 1, wherein the data manager circuit comprises a processor and code executable by the processor.

9. The device of claim 1, wherein the data manager circuit comprises memory and code stored in the memory.

10. The device of claim 9, wherein the code comprises firmware of the electronic equipment.

11. The device of claim 1, wherein the data manager circuit is implemented in hardware.

12. A method of transferring at least one of a first data or a second data to/from electronic equipment, comprising:
exchanging the first data and/or second data over a first communication medium;
monitoring a first characteristic of the first communication medium;
comparing the first characteristic to a user settable parameter to determine an availability of the first communication medium; and
automatically starting, stopping, and resuming data transfer over the first communication medium based on the availability of the communication medium.

13. The method of claim 12, wherein comparing the characteristic to the user settable parameter includes using a user parameter that corresponds to at least one of a valid communication link over the communication medium, a predetermined data transfer rate over the communication medium, or a transfer cost per unit data over the communication medium.

14. The method of claim 12, wherein resuming data transfer includes continuing data transfer from a point in which the data transfer was interrupted.

15. The method of claim 12, further comprising
exchanging at least one of the first data or the second data over a second communication medium;
monitoring a characteristic of the second communication medium; and
comparing the characteristic of the second communication medium to the user settable parameter to determine an availability of the second communication medium.

16. The method of claim 15, further comprising:
prioritizing the first and second communication medium;
using the higher priority communication medium when the higher priority communication medium is available; and
using the lower priority communication medium when the higher priority communication medium is not available.

17. The method of claim 16, further comprising periodically determining an availability of each communication medium.

18. The method of claim 12, wherein the electronic equipment is a mobile phone.

19. The method of claim 12, wherein the first communication medium is at least one of a local area network, a wide area network, a peer-to-peer network, or an internet connection, and the second communication medium is a mobile phone network.

20. The method of claim 12, wherein exchanging includes transferring the first and/or second data between the electronic equipment and at least one of a PC, another electronic equipment, or a server operated by a service provider.

21. A computer program embodied on a computer readable medium for transferring at least one of a first data or a second data to/from electronic equipment, comprising:
code that exchanges the first data and/or second data over a first communication medium; and
code that monitors a characteristic of the first communication medium;
code that compares the characteristic to a user settable parameter to determine an availability of the first communication medium; and
code that automatically starts, stops, and resumes data transfer over the first communication medium based on the availability of the first communication medium.

22. A method of transferring at least a first data to/from electronic equipment, comprising:
monitoring a first parameter of a first communication medium;
monitoring a second parameter of a second communication medium, said second communication medium having a different topology than the first communication medium;
comparing the first parameter and the second parameter to a user settable parameter, said user settable parameter defining a selection criteria; and
selecting the communication medium that best satisfies the selection criteria.
